(19) United States
(12) Patent Application Publication
(10) Pub. No.: US 2016/0217639 A1
(43) Pub. Date: Jul. 28, 2016

(54) CONTAINER FOR DOCUMENTS OF VALUE

(71) Applicant: CI TECH COMPONENTS AG, Burgdorf (CH)

(72) Inventors: Xavier THUM, Wolfratshausen (DE); Helmut STEIDL, München (DE)

(21) Appl. No.: 14/908,861

(22) PCT Filed: Aug. 1, 2014
(86) PCT No.: PCT/EP2014/066578

§ 371 Date: Jan. 29, 2016

(30) Foreign Application Priority Data
Aug. 1, 2013 (DE) 10 2013 108 244.0

(51) Int. Cl. G07D 11/00

(52) U.S. Cl. CPC G07D 11/0006; G07D 11/0021

(57) ABSTRACT

A container for sheet goods, in particular for value documents, such as bank notes, includes at least a first sheet-goods region having an input opening for inputting sheet goods to the first sheet-goods region, so that the first sheet-goods region can assume a first filling state increasing in time, and at least a second sheet-goods regions, separate from the first sheet-goods region, having an output opening for outputting sheet goods received in the second sheet-goods region, so that the second sheet-goods region can assume a second filling state decreasing in time. The first sheet-goods region and the second sheet-goods region are variable such that in dependence on the filling state of the first sheet-goods region and of the second sheet-goods region a partial volume of the container can belong to the first sheet-goods region at a first time and to the second sheet-goods region at a second time.

The present invention concerns a container for sheet goods, in particular for value documents, such as bank notes. The sheet-goods container may be in particular a bank-note cassette. The invention furthermore concerns a method and an apparatus for processing sheet goods with a suitable sheet-goods container.

In an apparatus for processing sheet goods, for example a bank-note machine which is provided for inputting and outputting hank notes, different kinds of bank-note containers can be employed. Depending on the case of application, bank-note containers can be used in the bank-note machine that are intended only for receiving bank notes (so-called deposit cassettes or deposit stores). Such containers are for storing in a final manner bank notes that are not to be outputted again. Furthermore, so-called dispense cassettes or dispense stores can be used. This kind of bank-note container is inserted in a filled state into the bank-note machine, for example in each case a cassette with bank notes of a certain denomination. The dispense cassettes serve only to supply change. A disadvantage of the stated bank-note cassettes is the high space requirement, since every container requires a separate place in the bank-note machine.

Furthermore, a sheet-goods processing apparatus also contains so-called “recyclers”. These are storage regions where bank notes are stored temporarily. That is, the bank notes are first received therein and later outputted therefrom again. For example, a film-type winding store works on the LIFO principle (last-in-first-out). It is also known to ram bank notes into a bank-note container from above in order to output them again from the same container from below at a later time according to the FIFO principle (first-in-first-out) (U.S. Pat. No. 5,499,805).

The object of the present invention is to reduce the space requirement of sheet-goods containers in an apparatus for processing sheet goods.

This object is achieved by a container for sheet goods as well as a method and an apparatus for processing sheet goods having the features of the independent claims. Developments and advantageous embodiments are stated in the claims dependent thereon.

According to the invention, there is provided a container for sheet goods, in particular for value documents, such as bank notes, which comprises at least a first sheet-goods region and at least a second sheet-goods region separate from the first sheet-goods region. The first sheet-goods region has an input opening for inputting sheet goods to the first sheet-goods region, so that the first sheet-goods region can assume a first filling state increasing in the course of time. The second sheet-goods region has an output opening for outputting sheet goods received in the second sheet-goods region, so that the second sheet-goods region can assume a second filling state decreasing in the course of time. In other words, the first sheet-goods region corresponds functionally to a deposit cassette because it is intended only for receiving bank notes, while the second sheet-goods region corresponds functionally to a dispense cassette because bank notes are only outputted therefrom, so that the first sheet-goods region can also be designated a deposit region and the second sheet-goods region also a dispense region.

The first sheet-goods region and the second sheet-goods region are configured to be variable such that in dependence on the respective filling state of the first and the second sheet-goods region a partial volume of the container can belong to the first sheet-goods region at a first time and to the second sheet-goods region at a second time. The first and second sheet-goods regions therefore share a partial volume of the container. While the first sheet-goods region is empty or filled to a low degree at a first time, the space in the container that is not required by the first sheet-goods region can be occupied by the second sheet-goods region, which can have a high filling state at said first time. In the course of time the filling state of the second sheet-goods region will decrease while the filling state of the first region increases. The container's partial volume that is gradually released by the second sheet-goods region can then be occupied by the first sheet-goods region.

In this manner, space can be saved in an apparatus for processing sheet goods, such as a bank-note machine, since the container according to the invention only occupies one place in the apparatus but combines the function of a deposit cassette and a dispense cassette. Although the two regions for deposit, on the one hand, and dispense, on the other hand, remain strictly separate from each other, in principle exactly as when employing two separate containers, a partial volume of the container can be utilized variably for both functions. Unutilized empty room in the apparatus is therefore reduced, and the space available in the apparatus is better exploited than when employing two separate deposit and dispense cassettes. Thus, either the combined container can be smaller than two separate deposit and dispense cassettes, or the doubly utilized partial volume can be employed for supplying an increased quantity of change and/or accepting more bank notes. Both can lead to longer times in service and less frequent changes of cassettes. The combined container furthermore simplifies handling, since now only one container, instead of two containers, has to be exchanged and opened for filling or emptying.

When employing conventional containers it may be necessary that all bank notes be conveyed into the deposit cassette for bank notes remaining in the apparatus to be transported off, i.e. the content of the dispense cassette(s) must be shifted into the deposit cassette(s). Since the container according to the invention has both a deposit region and a dispense region, such rearranging is not compulsory.

Preferably, the first sheet-goods region has bordering thereon a first sheet-goods support, and the second sheet-goods region a second sheet-goods support. The first and second sheet-goods supports are respectively displaceable along a direction perpendicular to the corresponding sheet-goods supporting surface, so that the volumes of the first and second sheet-goods regions are variable. In particular, the sheet-goods supports can be formed by a plane platform. Preferably, the first sheet-goods support and the second sheet-goods support are arranged parallel to each other. The two sheet-goods supports can be formed for example by separately displaceable plates in the container or by two opposing sides of one displaceable plate. The sheet-goods supports can alternatively also be formed by a grid, by rods or other support points which preferably define a plane or two planes.

The first and second sheet-goods supports are preferably displaceable in dependence on the respective fill state of the first and second sheet-goods regions, so that the partial volume of the container can belong to the first sheet-goods region at the first time and to the second sheet-goods region at the second time. Preferably, the first sheet-goods support and the second sheet-goods support are arranged displaceably such that a volume of the first or second sheet-goods region is reducible to zero, while the volume of the accordingly other of the first and second sheet-goods regions is maximizable. Therefore, the total volume of the container can be optimally utilized, since a volume not required by the first sheet-goods region can be utilized substantially completely by the second sheet-goods region, and/or vice versa. The container's partial volume that can belong to the first sheet-goods region at the first time and to the second sheet-goods region at the second time can therefore advantageously occupy substantially the container's total volume. In this manner, the utilization of the available space is further optimized.

Preferably, the container comprises at least one tensioning apparatus, such as a spring apparatus, which urges at least one of the first and second sheet-goods supports in the direction of the appurtenant first or second sheet-goods region. Preferably, the tensioning apparatus urges both the first sheet-goods support in the direction of the first sheet-goods region and the second sheet-goods support in the direction of the second sheet-goods region. Preferably, the tensioning apparatus is arranged between the first and second sheet-goods supports. The tensioning apparatus can therefore urge the first sheet-goods support and the second sheet-goods support away from each other in the direction of the respective appurtenant sheet-goods region. There can for example be arranged between the two sheet-goods supports a spring which urges the sheet-goods supports apart. This simple construction allows the volume of the first and second sheet-goods regions to be respectively adapted automatically to the filling state of the first or second sheet-goods region. Furthermore, sheet goods located in the first and second sheet-goods regions are respectively compressed by the tensioning apparatus, which is advantageous for inputting sheet goods to the first sheet-goods region and outputting sheet goods from the second sheet-goods region.

Alternatively or additionally to the tensioning apparatus, there can also be provided an electric motor which actively shifts at least one of the first and second sheet-goods supports. This can be advantageous for example to keep the pressure constant on sheet goods located in the first and/or second sheet-goods region. Both the first and the second sheet-goods support can be shifted actively by means of an electric motor. It is also possible to actively shift only one of the two sheet-goods supports, while the other sheet-goods support is coupled to the actively shifted sheet-goods support for example by means of a tensioning apparatus. Independently of the drive, the first and/or second sheet-goods support can be guided within the container for example in slide rails or by means of gears in order to avoid wedging upon shifting of the respective sheet-goods support.

Preferably, the first and second sheet-goods supports are arranged between the first and second sheet-goods regions. The first and second sheet-goods supports therefore act as a strict separation of the first sheet-goods region from the second sheet-goods region. For example, the first sheet-goods region can be located in an upper region of the container and the second sheet-goods region in a lower region of the container, with the first and second sheet-goods supports being displaceable therebetween. The arrangement can of course also be the reverse.

As mentioned, the deposit region serves only for receiving bank notes that are not outputted again. Accordingly, said region possesses only an input opening and no opening or device via which bank notes could be outputted from the deposit region during operation of the apparatus.

In an advantageous embodiment of the container, the input opening of the first sheet-goods region is configured for interacting with a device for ramming in sheet goods, so that sheet goods can be rammed into the first sheet-goods region through the input opening. The input opening can for this purpose be configured in a manner known to the skilled person, in particular so as to allow opening during ramming and to retain sheet goods rammed into the first sheet-goods region when the ram apparatus withdraws.

In contrast, the dispense region serves, as mentioned, only for outputting bank notes (change) stockpiled in the dispense region. Said region is not intended for receiving bank notes during operation of the apparatus. Accordingly, said region possesses only an output opening and no opening or device via which bank notes could be fed to the deposit region during operation. For the purpose of outputting bank notes there can be provided a singler which is configured for singling sheet goods out of the second sheet-goods region and outputting the singled sheet goods through the output opening of the second sheet-goods region. The singler can likewise be configured in a manner known to the skilled person, for example by rollers that strip sheet goods to be singled from a sheet-goods stack in the second sheet-goods region and transport them off.

it is further advantageous when the container comprises a storage apparatus for storing data relating to the sheet goods that are located in the first sheet-goods region and/or the second sheet-goods region. Preferably, the storage apparatus is configured to store both data relating to the sheet goods in the first sheet-goods region and data relating to the sheet goods in the second sheet-goods region. Therefore, the filling states of the first and/or second sheet-goods region can be simply recorded and read out and utilized for example for generating a signal for when the container must be exchanged.

The sheet-goods container is preferably used in an apparatus for processing sheet goods, in particular value documents such as bank notes. The apparatus comprises an input device for inputting sheet goods and an output device for outputting sheet goods. Said devices may be slots or pockets into which or out of which sheet goods, such as bank notes, can be inputted or outputted. The input device and the output device can also be combined, i.e. the sheet goods are also outputted again through the input device. Furthermore, the apparatus preferably has at least one transport path for transporting sheet goods. The container is connected to the input device and the output device by means of the transport path.

Preferably, the transport path is configured for transporting sheet goods from the input device to the first sheet-goods region of the container in which they remain and out of which they are not outputted again, and for transporting sheet goods out of the second sheet-goods region of the container to the output device, e.g. as change. The container is therefore joined to the transport path on both sides in order to enable sheet goods to be inputted to the first sheet-goods region, e.g. bank notes of great denomination for which there is no separate deposit cassette in the apparatus, and sheet goods to be outputted from the second sheet-goods region, e.g. change in the form of bank notes of smaller denomination which are required especially frequently.

The apparatus preferably comprises a device for ramming sheet goods into the first sheet-goods region. Said device preferably interacts with the input opening of the container such that an individual piece of sheet goods or also a sheet-goods stack can be rammed into the first sheet-goods region. The apparatus can furthermore comprise a singler which interacts with the output opening of the second sheet-goods region and is configured for singling sheet goods out of the second sheet-goods region.

Furthermore, the apparatus for processing sheet goods preferably comprises one or more intermediate stores (so-called recyclers) for temporarily receiving sheet goods, The intermediate store does not serve for receiving sheet goods in a final manner, but is intended for outputting the temporarily stored sheet goods again for example due to an abort of the input operation or in the case of non-acceptance of the sheet goods, or also for outputting them in a subsequent operation, for example as change. The intermediate store is preferably configured as a film-type store, which is in principle known to the skilled person. Sheet goods are wound here between two films onto a reel, with the last stored sheet goods being outputted again first by the reel being unwound in the reverse direction. The apparatus can furthermore also additionally have one or more final stores (outright deposit cassettes) and/or one or more output stores (outright dispense cassettes).

A method employing the described combined sheet-goods container can accordingly comprise the following steps:

a) inserting the container into a sheet-goods processing apparatus, with the first sheet-goods region being empty or predominantly empty and the second sheet-goods region being filled or predominantly filled,

b) inputting sheet goods to the sheet-goods processing apparatus,

c) automatically placing at least a portion of the inputted sheet goods into the first sheet-goods region,

d) automatically outputting sheet goods received in the second sheet-goods region, e.g. as change, and

e) opening the container and removing the total sheet goods placed into the first sheet-goods region.

The steps c) and d) can also be carried out in the reverse order. From the fact that the total sheet goods placed into the first sheet-goods region are removed from the relevant sheet-goods region after opening of the cassette, it results that the total sheet goods remain in the region and in particular are not outputted again, as is usual with deposit cassettes. For removal of the sheet goods placed in the deposit region, in particular rammed in, the side wall of the sheet-goods container is opened, which can be configured for example as a door. For this purpose, the sheet-goods container is normally previously removed from the processing apparatus. Not only the sheet goods placed into the deposit region are removed from the cassette, of course, but any sheet goods remaining in the dispense region are likewise removed. While there can be held in the dispense region for example bank notes of smaller denominations, which are required as change to a higher degree, there can be placed in the deposit region bank notes of greater denomination, for example bank notes greater than or equal to 100 EUR, for which no separate store is provided in the apparatus.

The invention will be described hereinafter by way of example with reference to the schematic drawings. Therein are shown:

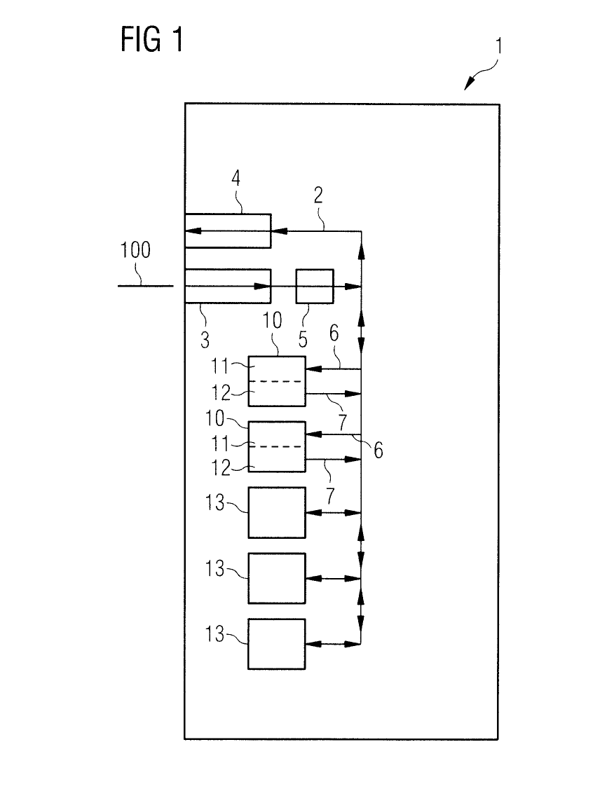

FIG. 1 a schematic overview of an apparatus for processing sheet goods,

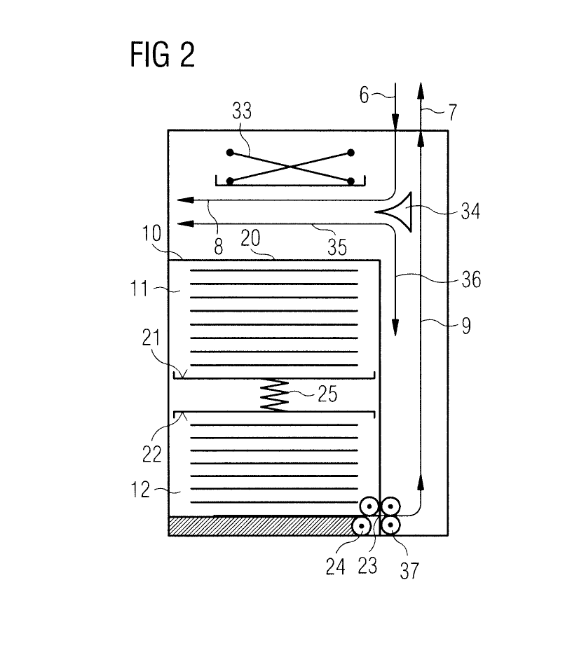

FIG. 2 a schematic detail view of the apparatus from FIG. 1 with a sheet-goods container according to the invention,

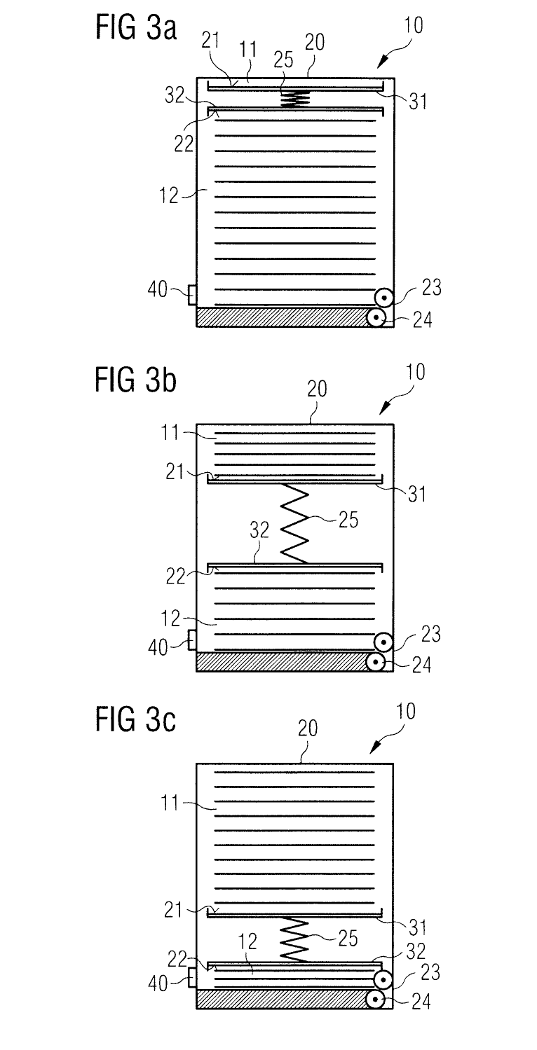

FIGS. 3a to 3c a schematic representation of a first embodiment example of a container for sheet goods with different fill levels,

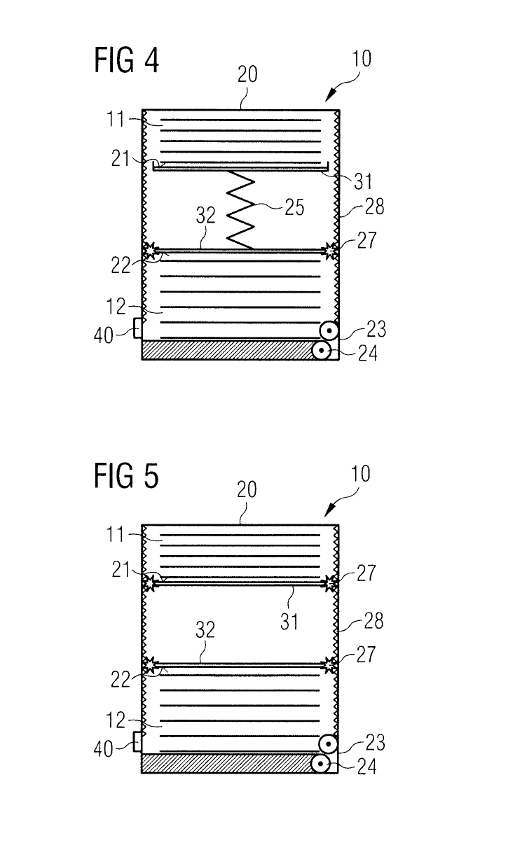

FIG. 4 a schematic representation of a second embodiment example of a container for sheet goods,

FIG. 5 a schematic representation of a third embodiment example of a container for sheet goods, and

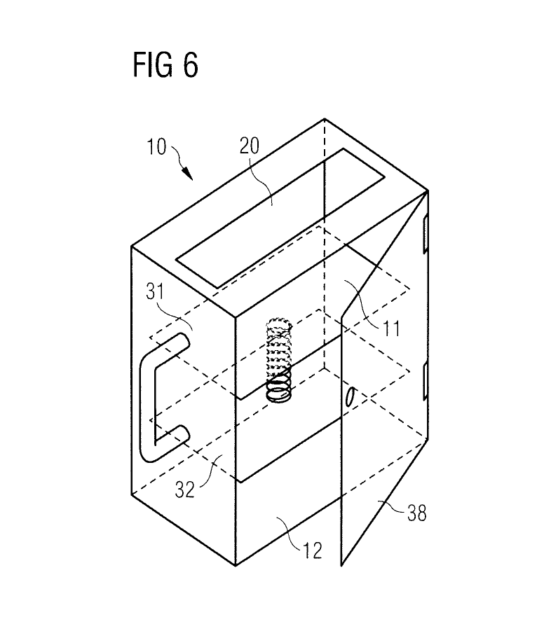

FIG. 6 a schematic representation of an open container for sheet goods.

In FIG. 1 is represented an apparatus for processing sheet goods in the form of a bank-note machine 1. The drawing is only intended to schematically represent individual components of the bank-note machine 1 and their functional connection to each other. It will be appreciated that the bank-note machine can have further and/or other components. The bank-note machine 1 has an input device 3, such as an input pocket for a bank-note stack or a feeder for individual bank notes 100, to which a user can input one or more bank notes 100. For paying out, the machine 1 has an output device 4 from which the user can remove bank notes. The output device 4 can be configured like the input device 3 as a pocket or slot in the known manner. After a bank note 100 is inputted it is checked in a checking device 5 for denomination, authenticity, state and/or further features before being passed to the transport path 2. Via the transport path 2, which can contain in particular rails, transport rollers and gates in the known manner, an inputted bank note can be passed to different stores, as will be described in detail hereinafter.

In the shown embodiment example, the bank-note machine 1 comprises two bank-note containers 10 according to the invention which respectively have a deposit region 11 and a dispense region 12. A transport-path portion 6 leads to the deposit region 11 of the container 10, while a transport-path portion 7 leads away from the dispense region 12 of the container 10.

Furthermore, the bank-note machine it has three intermediate stores 13. The intermediate stores 13 serve for temporarily receiving bank notes of different denomination. For example, bank notes inputted by a user are first stored in the intermediate stores 13 in order to be outputtable again for example in the case of an abort of the operation. Only at the end of the operation are the bank notes placed in a deposit store in a final manner, i.e. in the deposit region 11 of the containers 10. This function of the intermediate stores 13 is also designated “escrow”. Further, it may be expedient to keep some bank notes in the intermediate stores 13 so as to be available for subsequent operations, for example to accelerate payouts and not unnecessarily tax the stocks of the dispense stores, i.e. the dispense region 12 of the containers 10. This function of the intermediate stores 13 is designated “recycler”. The intermediate stores 13 are preferably configured as film-type stores. In this basically known type, bank notes are wound, on the LIFO principle (last-in-first-out), between two films onto a reel in the order of their input and can be outputted again in the reverse order by unwinding the reel.

In FIG. 2 is represented schematically a. detail view of one of the bank-note containers 10 configured as a combined deposit/dispense cassette, in particular with regard to its connection to the transport path 2. As briefly explained hereinabove, a transport-path portion 6, 8 leads to the deposit region 11 of the container, so that bank notes can be placed in the deposit region 11. For transporting off bank notes removed from the dispense region 12, a transport-path portion 7, 9 leads away from the dispense region 12.

For bringing fed bank notes into the deposit region 11 of the container 10, a ram apparatus 33 is arranged above an input opening 20. The rain apparatus 33 can ram individual bank notes or also a bank-note stack into the container through the input opening 20. For this purpose, a bank note is passed from the transport-path portion 6 into the transport-path portion 8 from where it can be rammed into the container 10. If a hank-note stack is to be bundled, for adding a bank note to a stack an already formed stack is first displaced from a transport-path portion 35 into a transport-path portion 36. For this purpose, a three-way gate 34 is provided. While a new bank note is subsequently passed from the transport-path portion 6 into the transport-path portion 8, the previously displaced stack is passed back into the transport-path portion 35 and thus brought together with the new bank note. Thus, all bank notes to be placed down in one operation can for example be bundled in a stack and jointly rammed into the container 10. It will be appreciated that the bank notes can also be brought into the deposit region 11 of the container 10 and stacked in a different manner.

For removal of bank notes from the dispense region 12 of the container 10 there is provided in the container a singler 24 which can strip individual bank notes from the dispense region 12 and convey them out of the container 10 through an output opening 23. The bank notes can be accepted through external stripping rollers 37 and passed via the transport-path portion 9 to the transport-path portion 7. It will be appreciated that for singling the bank notes received in the dispense region 12 a singler which is located either inside or outside the container 10 may also be sufficient.

In FIGS. 3a to 3c is represented a first embodiment example of a bank-note container 10 as a combined deposit/dispense cassette. As explained hereinabove, the container 10 has a deposit region 11 as well as a dispense region 12 strictly separate therefrom. Via the input opening 20 bank notes can be brought into the deposit region 11, while through the output opening 23 bank notes can be removed from the dispense region 12 by means of the singler 24. The bank notes cannot pass from one region to the other within the cassette.

Between the deposit region 1 and the dispense region 12 there are located as a separation of the two regions 11, 12 two movable platforms 31, 32 which form a first bank-note support 21 and a second bank-note support 22. The first bank-note support 21 borders on the deposit region 11, and the second bank-note support 22 on the dispense region 12. In this embodiment example, the two platforms 31, 32 are urged apart by a spring apparatus 25 in the direction of the deposit region 11 and dispense region 12, respectively. To prevent wedging of the platforms 31, 32 they can be movably guided. Due to the spring force, the volumes of the deposit region 11 and of the dispense region 12 automatically adapt to a quantity of bank notes respectively contained therein. A compressing of the bank-note stacks is important also because it simplifies or, where applicable, actually enables the ramming of bank notes into the deposit region 11 and the singling of bank notes out of the dispense region 12.

In FIG. 3a the container 10 is represented in a filling state in which it is usually inserted into a bank-note machine 1. The deposit region 11 is empty and the dispense region 12 is filled. It can be seen that in this filling state the volume of the dispense region 12 occupies substantially the total volume of the container 10, while the volume of the deposit region 11 is substantially zero. The volume of the deposit region 11 is at least reduced to a minimum, while the volume of the dispense region 12 is maximized. The volume of a region is regarded here in particular as that volume able to receive bank notes. Space is saved since no unnecessary empty room is kept available. The volume not required by the deposit region 11 can be occupied by the dispense region 12. In other words, there is associated with the dispense region 12 at this time a partial volume of the container 10 that is associated with the deposit region 11 at a later time. This is represented in FIGS. 3b and 3c.

In FIG. 3b a portion of the bank notes contained in the dispense region 12 at the beginning has been removed. The volume that has become free is partly occupied by the deposit region 11 which fills in the course of time. The spring apparatus 25 ensures compensation when the deposit region 11 does not fill to the same degree as the dispense region 12 empties. The distance between the two platforms 31, 32 is greater in FIG. 3b than in FIG. 3a. The spring apparatus 25 can preferably assume a length so as to cover the total container height, i.e. in case the container 10 is completely empty.

In FIG. 3c is finally represented a further, later time. The deposit region 11 has filled further and the dispense region 12 has emptied further. The deposit region 11 gradually takes over further volume portions of the container 10 that were previously associated with the dispense region 12. There is provided a storage device 40 on which the filling states of both the deposit region 11 and the dispense region 12 are stored, so that the current filling state of the container 10 can be established at any time in order to be able to ascertain for example when the container 10 must be exchanged, for example because the dispense region 12 is empty or the deposit region 11 is full.

In FIG. 4 there is represented a second embodiment example of a bank-note container 10 which corresponds substantially to the embodiment example from FIGS. 3a to 3c. The difference consists in that the platform 32 with the bank-note support 22 is actively shiftable. For this purpose there can be provided an electric motor which drives drivegears 27 which engage toothed rails 28. In this manner the position of the bank-note support 22 can be actively controlled to thereby for example keep the pressure constant on bank notes in the dispense region 12. It will be appreciated that other drives can be employed that allow active shifting of the bank-note support 22, such as a linear motor. In this embodiment example, the platform 31 with the bank-note support 21 is coupled to the actively shiftable platform 32 by means of a spring apparatus 25. The volume of the deposit region 11 is therefore regulated by means of the spring force. It will be appreciated that the platform 31 can also conversely be actively shiftable and the platform 32 coupled to the platform 31 by means of a spring apparatus. FIG. 4 shows a filling state that corresponds approximately to the filling state represented in FIG. 3b. With regard to the mode of function, in particular the time course of the filling states, reference is made to the description for FIGS. 3a to 3c.

A third embodiment example of a bank-note container 10 is represented in FIG. 5, corresponding substantially to the above-described embodiment examples and showing a filling state as in FIG. 4. In contrast to the above-described embodiment examples, in the embodiment example according to FIG. 5 both platforms 31, 32 are actively shiftable, as described for the platform 32 in connection with FIG. 4. Therefore, in this embodiment example the volume of the deposit region 11 can also be actively adjusted and the pressure on the bank notes in the deposit region 11 kept constant. The active shift of both platforms 31, 32 facilitates the reaching of the position at which both the deposit region 11 and the dispense region 12 are empty, since no long spring apparatus is required, The position of the platforms 31, 32 (or of only one of the platforms as in FIG. 4) can be determined for example using a pressure sensor which senses the pressure of the platforms 31, 32 on the corresponding sheet-goods stack in the deposit region 11 or dispense region 12.

In FIG. 6 there is finally represented a bank-note container 10 in an open state. One of the side walls is accordingly configured as a door 38, so that the interior of the bank-note container 10 is accessible, in particular the deposit region 11 and the dispense region 12, In this manner, bank notes can be removed from the bank-note container 10, in particular from the deposit region 11 and, where applicable, also from the dispense region 12, and the dispense region 12 be refilled, outside the bank-note machine 1. Advantageously, the movable platforms 31, 32 can in so doing be displaced manually to enable a bank-note stack to be removed or inserted. The bank-note container 10 can thus, as a reusable container, be prepared for a new use.

1. A container for sheet goods, in particular for value documents, such as bank notes, comprising at least a first sheet-goods region having an input opening for inputting sheet goods to the first sheet-goods region from which the sheet goods cannot be outputted again, so that the sheet goods remain in the first sheet-goods region and the first sheet-goods region can assume a first filling state increasing in time, and at least a second sheet-goods region, strictly separate from the first sheet-goods region, having an output opening for outputting sheet goods received in the second sheet-goods region, so that the second sheet-goods region can assume a second filling state decreasing in time, wherein the first sheet-goods region and the second sheet-goods region are variable such that in dependence on a respective filling state of the first sheet-goods region and of the second sheet-goods region a partial volume of the container can belong to the first sheet-goods region at a first time and to the second sheet-goods region at a second time.

2. The container according to claim 1, wherein the first sheet-goods region has bordering thereon a first sheet-goods support which is displaceable along a direction perpendicular to the supporting surface of the first sheet-goods support, and the second sheet-goods region has bordering thereon a second sheet-goods support which is displaceable along a direction perpendicular to the supporting surface of the second sheet-goods support.

3. The container according to claim 2, wherein the first sheet-goods support and the second sheet-goods support are arranged displaceably such that a volume of the first sheet-goods region or of the second sheet-goods region is reducible to zero, while the volume of the accordingly other of the first and second sheet-goods regions is maximizable.

4. The container according to claim 2, comprising at least one tensioning apparatus which is configured for urging at least one of the first and second sheet-goods supports in the direction of the appurtenant first or second sheet-goods region.

5. The container according to claim 4, wherein the tensioning apparatus is arranged between the first sheet-goods support and the second sheet-goods support.

6. The container according to claim 2, comprising an electric motor for actively shifting at least one of the first and second sheet-goods supports.

7. The container according to claim 2, wherein the first and second sheet-goods supports are arranged between the first sheet-goods region and the second sheet-goods region.

8. The container according to claim 1, wherein the input opening is configured for interacting with a device for ramming in sheet goods, so that sheet goods can be rammed into the first sheet-goods region through the input opening.

9. The container according to claim 1, comprising a singler which is configured for singling sheet goods out of the second sheet-goods region and outputting sheet goods through the output opening.

10. The container according to claim 1, comprising a storage apparatus for storing data relating to sheet goods received in the first sheet-goods region and/or in the second sheet-goods region.

11. An apparatus for processing sheet goods, in particular value documents, such as bank notes, comprising:
an input device for inputting sheet goods;
an output device for outputting sheet goods;
at least one transport path for transporting sheet goods; and
at least one container for sheet goods which is connected to the input device and the output device via the transport path, comprising at least a first sheet-goods region having an input opening for inputting sheet goods to the first sheet-goods region, so that the first sheet-goods region can assume a first filling state increasing in the course of time, and at least a second sheet-goods region, strictly separate from the first sheet-goods region, having an output opening for outputting sheet goods received in the second sheet-goods region, so that the second sheet-goods region can assume a second filling state decreasing in the course of time, wherein the first sheet-goods region and the second sheet-goods region are variable such that in dependence on the respective filling state of the first sheet-goods region and of the second sheet-goods region a partial volume of the container can belong to the first sheet-goods region at a first time and to the second sheet-goods region at a second time, wherein the apparatus is configured for outputting sheet goods from the container only via the output opening of the second sheet-goods region and only placing sheet goods into the first sheet-goods region of the container.

12. The apparatus according to claim 11, comprising a device for ramming sheet goods into the first sheet-goods region.

13. The apparatus according to claim 11, comprising a singler which interacts with the output opening of the second sheet-goods region and is configured for singling sheet goods out of the second sheet-goods region.

14. The apparatus according to claim 11, wherein the transport path is configured for transporting sheet goods from the input device to the first sheet-goods region of the container and for transporting sheet goods out of the second sheet-goods region of the container to the output device.

15. The apparatus according to claim 11, comprising one or more intermediate stores, preferably as film-type stores, for temporarily receiving sheet goods.

16. A method for processing sheet goods employing a sheet-goods container which comprises at least a first sheet-goods region having an input opening for inputting sheet goods to the first sheet-goods region, so that the first sheet-goods region can assume a first filling state increasing in the course of time and which comprises at least a second sheet-goods region, separate from the first sheet-goods region, having an output opening for outputting sheet goods received in the second sheet-goods region, so that the second sheet-goods region can assume a second filling state decreasing in the course of time, wherein the first sheet-goods region and the second sheet-goods region are variable such that in dependence on the respective filling state of the first sheet-goods region and of the second sheet-goods region a partial volume of the container can belong to the first sheet-goods region at a first time and to the second sheet-goods region at a second time, wherein the method comprises:
inserting the container into a sheet-goods processing apparatus (1), with the first sheet-goods region being empty or predominantly empty and the second sheet-goods region being filled or predominantly filled;
inputting sheet goods to the sheet-goods processing apparatus;
automatically placing at least a portion of the inputted sheet goods into the first sheet-goods region;
automatically outputting sheet goods received in the second sheet-goods region; and
opening the container and removing the total sheet goods placed into the first sheet-goods region.
